(19) United States
(12) Patent Application Publication
(10) Pub. No.: US 2016/0159064 A1
(43) Pub. Date: Jun. 9, 2016

(54) Electrochemical Method for Transferring Graphene

(71) Applicant: DANMARKS TEKNISKE UNIVERSITET, Kgs. Lyngby (DK)

(72) Inventors: Filippo Pizzocchero, Copenhagen (DK); Timothy John Booth, Virum (DK); Natalie Kostesha, Virum (DK); Letizia Amato, Copenhagen (DK); Peter Bøggild, Copenhagen (DK)

(21) Appl. No.: 14/904,546

(22) PCT Filed: Jul. 11, 2014
(86) PCT No.: PCT/EP2014/064944

§ 371 Date: Jan. 12, 2016

(30) Foreign Application Priority Data
Jul. 12, 2013 (EP) 13176321.1

(51) Int. Cl. B32B 38/00; C25F 3/02

(52) U.S. Cl. CPC B32B 38/0008; C25F 3/02; B32B 2305/07; B32B 2310/021; B32B 2313/04; B32B 2457/00

(57) ABSTRACT

The present application discloses a method for separating a graphene-support layer laminate from a conducting substrate-graphene-support layer laminate, using a gentle, controllable electrochemical method. In this way, substrates which are fragile, expensive or difficult to manufacture can be used—and even re-used—without damage or destruction of the substrate or the graphene.

### FIELD OF THE INVENTION

The present invention relates to a method for separating a graphene-support layer laminate from a conducting substrate-graphene-support layer laminate, using a gentle, controllable electrochemical method. In this way, substrates which are fragile, expensive or difficult to manufacture can be used—and even re-used—without damage or destruction of the substrate, nor the graphene.

### BACKGROUND OF THE INVENTION

Although graphene shows promising properties as a material, researchers and manufacturers in the field suffer from a lack of high-quality graphene wafers in relatively large scale (larger than 1 mm²). High-quality graphene can be synthetized on conducting substrates using techniques such as Chemical Vapour Deposition (CVD), but must be transferred to other substrates if their electrical properties are to be exploited in any way. Current methods of graphene transfer do not provide high-quality wafer scale areas of graphene without compromising the growth substrate.

A particular problem arises when the conducting substrate upon which the graphene is deposited is particularly fragile, expensive or difficult to manufacture. For example, graphene may be deposited upon a thin metal film which has been grown upon a non-metal (e.g. silicon) substrate. Additionally, expensive metals such as Pt, Ir or Ru are often used as a growth substrate for graphene CVD. Furthermore, particular crystal faces of single-crystal conducting substrates are also useful as graphene CVD substrates. In all these instances, it is highly desirable that the catalyst substrate is not damaged or otherwise negatively affected by the graphene delamination process so that it can be re-used in subsequent CVD processes. This ultimately makes the use of much higher quality catalyst substrates feasible for real applications.

Research by Wang et al. (ACS Nano, 5, 12, 9927-9933, 2011 and WO 2013/043120) has used an electrochemical method to delaminate supported graphene from a metal substrate upon which it has been deposited. Reduction of water at the cathode creates hydrogen bubbles at the graphene/metal interface which detach the graphene by mechanically separating the graphene from the metal surface. This “bubbling” technique has since been used to delaminate other planar materials from other substrates. However, the method has its limitations, as the physical forces such as surface tension produced at the liquid-gas interface i.e. forces at the bubble wall can damage or break the graphene and can lead to rolling up or crumpling of the graphene. High quality (i.e. single unbroken layer) wafer-scale transfers have not yet been demonstrated by this method.

Yang et al. (J. Electroanalytical Chemistry 688 (2013) 243-248) discloses a method for clean and efficient transfer of CVD-grown graphene by complete electrochemical etching of a metal substrate. Such a method precludes the reuse of the catalyst substrate, and increases cost and complexity for the process, and will likely reduce commercial viability.

A method is required that preserves the quality of the deposited graphene after delamination from the substrate upon which it has been deposited, as well as preserving the quality of the metallic substrate.

### SUMMARY OF THE INVENTION

In a first aspect the present invention relates to a method for separating a graphene-support layer laminate from a conducting substrate-graphene-support layer laminate, said method comprising the steps of:
a. providing a N-electrode electrochemical system, where N is 3 or more, said N-electrode electrochemical system comprising:
   at least one working electrode (WE), at least one of which being said conducting substrate-graphene-support layer laminate (WE1),
   at least one reference electrode (RE),
   at least one counter electrode (CE), and
   at least one electrolyte (E) connecting said at least one working electrode (WE, WE1), said at least one reference electrode (RE) and said at least one counter electrode (CE), wherein said working electrode being said conducting substrate-graphene-support layer laminate (WE1) is in contact with a liquid electrolyte (E1) having a neutral or basic pH; and
b. applying a voltage at least between the working electrode (WE) which is said conducting substrate-graphene-support layer laminate (WE1) and at least one of said at least one counter electrodes (CE), and measuring the voltage between the working electrode (WE) which is said conducting substrate-graphene-support layer laminate (WE1) and at least one of said at least one reference electrodes (RE), such that the graphene-support layer laminate separates from said conducting substrate.

In a particular embodiment of the method, N=3 and the electrochemical system consists of:
a working electrode (WE), being said substrate-graphene-support layer laminate (WE1),
a reference electrode (RE),
one counter electrode (CE), and
liquid electrolyte (E1) connecting said working electrode (WE1), said reference electrode (RE) and said counter electrode (CE).

The invention also relates to an N-electrode electrochemical system for separating a graphene-support layer laminate from a substrate-graphene-support layer laminate, where N is 3 or more, said electrochemical system comprising:
at least one working electrode (WE), at least one of which being said substrate-graphene-support layer laminate,
at least one reference electrode (RE),
at least one counter electrode (CE), and
at least one electrolyte (E) connecting said at least one working electrode being said substrate-graphene-support layer laminate (WE1), said at least one reference electrode (RE) and said at least one counter electrode (CD), wherein said working electrode being said conducting substrate-graphene-support layer laminate (WE1) is in contact with a liquid electrolyte (E1) having a neutral or basic pH.

Again, in a particular embodiment, the N-electrode electrochemical system is provided in which N=3 and which consists of:
a working electrode (WE), being said substrate-graphene-support layer laminate (WE1),
a reference electrode (RE),
a counter electrode (CE), and
liquid electrolyte (E1) connecting said working electrode (WE1), said reference electrode (RE) and said counter electrode (CE).

Further aspects of the invention are apparent from the following description, figures, examples and the dependent claims.

### LEGENDS TO THE FIGURES

FIG. 1—(a) photograph of the 3-electrode version of the system for graphene transfer. On the left, the copper/graphene/support layer is held by tweezers (Working Electrode, WE). A commercial reference (RE) can be seen in the center and on the right a Pt coated Si/SiO₂ wafer as a counter electrode (CE). (b) Schematic of the set-up.

FIG. 2—(a) Optical image of graphene grown on copper foil transferred with the method of the invention onto SiO₂ (300 nm)/Si wafer. (b) Coverage map of the transferred graphene—white corresponds to the presence of graphene, black to its absence. (c) THz sheet conductance map of the same transferred film. The THz scale bar goes from 0 to 1.5 mS. The conductance of this film is distributed quite homogenously around 1 mS. Scale bars in figure are 3 mm.

FIG. 3—(a) Optical image of graphene grown on copper film (on 4″ wafer) transferred with the method of the invention onto SiO₂ (300 nm)/Si wafer. (b) THz sheet conductance map of the same transferred film. The THz scale bar goes from 0 to 15 normal conductance (expressed in 4 e²/h units). The conductance of this film is around 10 times 4 e²/h in the center and 5 at the edges. Scale bars in figure are 2.5 cm.

FIG. 4—THz sheet conductance maps of graphene film (a) Graphene film grown on one single piece of Cu foil and transferred with 3 different methods. In the first column, igraphene is transferred using the method of the invention, ii with the bubbling method (cf. Wang et al., ACS Nano, 5, 12, 9927-9933, 2011) and iii by chemical etching of the Cu foil by ammonium persulphate. The other 2 rows are transferred with same techniques, keeping the same order, but with the method of the invention being in ii in the second row and iii in the third one. The THz scale bar goes from 0 to 3 mS. The conductance of this film is distributed quite homogenously around 3 mS for the method of the invention, 1 mS for the etching and varies widely for the bubbling method, due to low coverage. Scale bar in figure is 6 mm. (b) The poor conductance relative to the bubbling method can be explained by the fragmentation of the graphene film (low coverage). (c) The film transferred with the method of the invention is instead continuous. Scale bars in figures b-c are 50 μm.

### DETAILED DISCLOSURE OF THE INVENTION

Definitions

The phrase “conducting substrate” describes materials with surfaces suitable for graphene growth, and which have electronic conductivity, i.e. resistivity smaller than 1MΩ*cm at room temperature. It also includes substrates which are semi-conducting, e.g. SiC.

When laminates in the present invention are described as X-Y-Z laminates, they comprise layers X, Y and Z in that order (i.e. X, then Y, then Z) without intervening layers.

Specific Aspects of the Invention

In a first aspect, the invention provides a method for separating a graphene-support layer laminate from a conducting substrate-graphene-support layer laminate.

The invention begins with a conducting substrate, which may be a metal or non-metal. Suitably, the conducting substrate is a metal, preferably Cu, Ni, Ir, Pt, Ru, Rh, Fe, W, Au, Ag, or alloys thereof. The conducting substrate may be a metal foil, a single crystal or a sputtered metal thin film on a carrier substrate. The conducting properties are required, as it is the conducting substrate which forms part of the electrical circuit when the separation method is carried out. The substrate is typically prepared by standard processing techniques (e.g. pressing, extrusion, spark plasma sintering (SPS), tape-casting, screen-printing, 3D printing, dip-coating, spin-coating, electrical anodization methods, etc.), or single crystal production methods.

Graphene is a one atom thin layer of carbon atoms arranged in a honeycomb (hexagonal) array. A high quality graphene layer is grown on the conducting substrate by chemical vapour deposition (CVD). Typical conditions for graphene CVD as used in the present invention are to be found in Nano Lett., 2009, 9 (1), pp 30-35 and ACS Nano, 2012, 6 (3), pp 2319-2325. A conducting substrate-graphene laminate is thus formed.

A substrate-graphene-support layer laminate is typically manufactured by:
i. providing a conducting substrate upon which graphene has been deposited;
ii. coating said graphene with a layer of support layer precursor, and
iii. optionally, treating said support layer precursor so as to provide a substrate-graphene-support layer laminate.

Commonly, the support layer is a polymer, and the support layer precursor is an uncured polymer. Coating the support layer precursor (uncured polymer) typically takes place by spin coating. The precursor could also be deposited by spraying or by drop casting. The support layer may be a polymer layer, suitably selected from PMMA, CAB, PS, PVC, PVA, or co-polymers or mixtures thereof. Common thicknesses are around few microns.

The step of treating the support layer precursor so as to provide a substrate-graphene-support layer laminate corresponds to a step of curing the uncured polymer. UV curing, chemical curing, thermal curing, or combinations thereof may be used.

In this way, a conducting substrate-graphene-support layer laminate is thus formed

In the method according to the first aspect of the invention, an N-electrode electrochemical system is provided, where N is 3 or more. Preferably N is 3, but may also be 4, 5, 6 7, 8 9 or 10 or more.

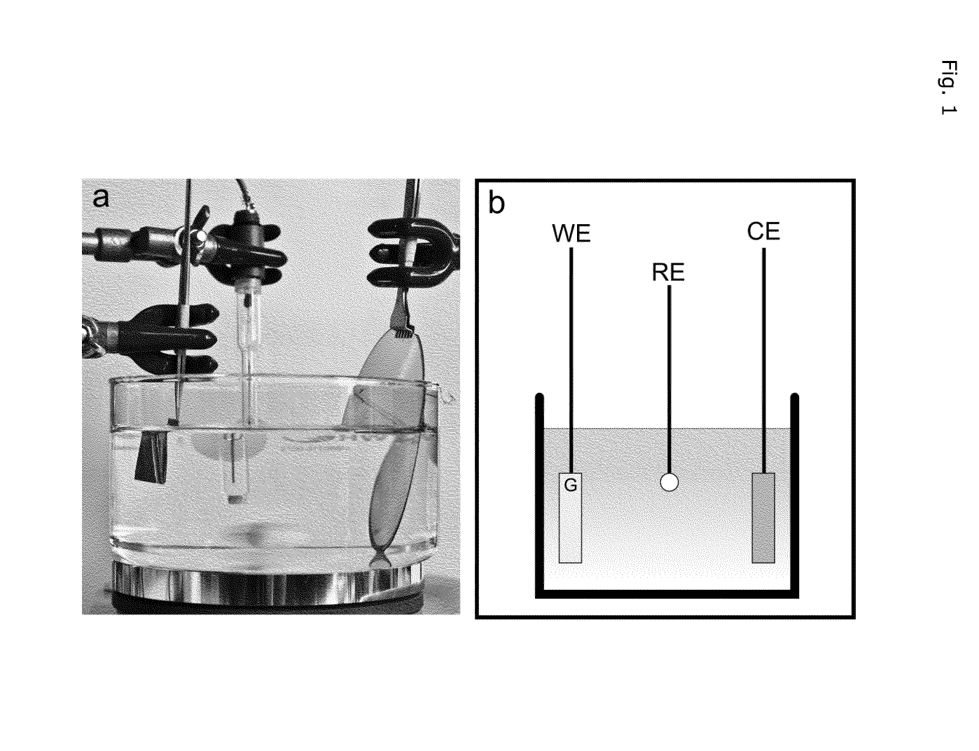

The N-electrode electrochemical system is shown in FIGS. 1a and 1b and comprises:
at least one working electrode (WE), at least one of which being said conducting substrate-graphene-support layer laminate (WE1),
at least one reference electrode (RE),
at least one counter electrode (CE).

The reference electrode may be any commonly-used reference electrode in electrochemistry. Most preferred is an SCE, or an Ag—AgCl electrode.

The counter electrode is typically an inert electrode, such as a noble metal such as Pt or Au electrode. Most preferred are counter electrodes with a large specific surface area. Alternatively, non-metal electrodes may be used as the counter electrode, e.g. glassy carbon, SiC.

In multichannel potentiostats it is possible to have M electrode systems (e.g. M reference electrodes, M counter electrodes, M working electrodes) controlled at once from the same potentiostat, where M is an integer from 1-20. Also, in single-channel potentiostats, it is possible to attach many physical WE and CE to the WE and CE output connections of the potentiostat simultaneously.

The electrochemical system also comprises at least one electrolyte E connecting said at least one working electrode (WE, WE1), said at least one reference electrode (RE) and said at least one counter electrode (CE). The electrodes are therefore connected in an electrical circuit with a potentiostat via the at least one electrolyte E. By the term “at least one electrolyte E” is meant that a plurality of electrolytes may be used, optionally with intervening salt bridges etc as desired by the skilled person. For instance, each type of electrolyte may be immersed in its own bath of electrolyte. However, as shown in FIGS. 1a and 1b, the electrodes are typically immersed in a single bath of the electrolyte (i.e. only one electrolyte E1 is present).

Importantly, the working electrode which is the conducting substrate-graphene-support layer laminate (WE1) is in contact with a liquid electrolyte (E1) having a neutral or basic pH. In the case illustrated in FIG. 1, the only electrolyte E is the liquid electrolyte E1.

In the particular embodiment illustrated, N=3 and the electrochemical system consists of:
a working electrode (WE), being said substrate-graphene-support layer laminate,
a reference electrode (RE),
one counter electrode (CE), and
liquid electrolyte connecting said at least one working electrode, said reference electrode and said at least one counter electrode.

The electrolytes (E) of the invention may be any typical electrolytes used in electrochemistry. The electrolytes E (and in particular liquid electrolyte E1) are suitably aqueous liquids, although non-aqueous liquids are also possible. The aqueous liquids are suitably aqueous solutions, which may comprise solutes such as surfactants, buffers and salts, or may involve controlled gas injection. Surfactants, such as Triton x-100 or TWEEN 85, are used to reduce the water surface tension with the purpose of minimizing the forces capable of destroying the graphene film. Commercial buffers such as those available from the Sigma-Aldrich company are used to precisely control the pH of the liquid. Salts, such as KCl or NaOH, are usually added to the aqueous liquid to introduce ions for the electrochemical reactions. Specific gases, as dry air, hydrogen or nitrogen, can be added to liquid electrolytes to create desired conditions, with the purpose of promoting or avoiding certain electrochemical reactions

The liquid electrolyte E1 has a neutral or basic pH. In this way, etching of the conducting substrate is minimised or even eliminated. The liquid electrolyte E1 suitably has a pH of 7 or more, such as 7.5 or more, such as 8 or more, such as 8.5 or more, such as 9 or more, such as 10 or more.

Once the N-electrode electrochemical system has been arranged as required, a voltage is applied at least between the working electrode (WE) which is said conducting substrate-graphene-support layer laminate (WE1) and at least one of said at least one counter electrodes (CE). At the same time, the voltage between the working electrode (WE) which is said conducting substrate-graphene-support layer laminate (WE1) and at least one of said at least one reference electrodes (RE) is measured. The voltage is typically kept fixed between the RE and the WE, while a current flows between the WE and the CE.

The graphene-support layer laminate separates thus from said conducting substrate. The graphene-support layer laminate can then be isolated.

A voltage is applied between the working electrode (WE) which is said conducting substrate-graphene-support layer laminate (WE1) and said counter electrode (CE). By means of the reference electrode, the electrochemical process (and hence the separation of the graphene-support layer laminate from said conducting substrate) is also carefully controlled. In particular, by carefully controlling the electrochemical process, the production of hydrogen bubbles at the working electrode (WE) which is said conducting substrate-graphene-support layer laminate (WE1) can be avoided. This provides a gentle method for separation of graphene from the conducting substrate. To avoid bubble formation, the voltage applied between the WE and the CE is suitably less than 3V, preferably less than 2V, more preferably less than 0.9 V.

In addition, the careful control allowed by the method according to the invention, means that the conducting substrate is suitably not completely etched by the electrolyte. In this way, conducting substrates which are fragile, expensive or difficult to manufacture can be preserved, and re-used.

The above-described method allows separation a graphene-support layer laminate from a conducting substrate-graphene-support layer laminate. The graphene-support layer laminate can then be isolated.

In an additional step, the isolated graphene-support layer laminate can be applied to a second substrate such that the graphene layer contacts the second substrate. The support layer can then be removed, e.g. by common methods such as dissolution of the support by a solvent or by evaporation of the support, thus leaving the graphene on the second substrate. In this way, graphene layers are ready to be used in a variety of electrical applications.

In a second aspect, the invention provides an N-electrode electrochemical system as such, as illustrated in a simple embodiment in FIGS. 1a and 1b. The electrochemical system is used for separating a graphene-support layer laminate from a substrate-graphene-support layer laminate. In the electrochemical system of the invention, N is 3 or more, preferably 3.

The electrochemical system comprises:
at least one working electrode (WE), at least one of which being said substrate-graphene-support layer laminate,
at least one reference electrode (RE),
at least one counter electrode (CE), and
at least one electrolyte (E) connecting said at least one working electrode being said substrate-graphene-support layer laminate (WE1), said at least one reference electrode (RE) and said at least one counter electrode (CD), wherein said working electrode being said conducting substrate-graphene-support layer laminate (WE1) is in contact with a liquid electrolyte (E1) having a neutral or basic pH.

All details of the electrochemical system described above for the method of the invention are also relevant for the electrochemical system per se. In particular, the nature of the liquid electrolyte E1 described above is of particular relevance. The liquid electrolyte E1 according to this aspect suitably has a pH of 7 or more, such as 7.5 or more, such as 8 or more, such as 8.5 or more, such as 9 or more, such as 10 or more. In particular, a single liquid electrolyte E1 may connect all electrodes (CE, WE, WE1, RE) of the N-electrode electrochemical system.

In the particular embodiment of FIGS. 1a and 1b, the N-electrode electrochemical system is a 3-electrode system (i.e. N=3) and consists of:
a working electrode (WE), being said substrate-graphene-support layer laminate (WE1),
a reference electrode (RE),
a counter electrode (CE), and
liquid electrolyte (E1) connecting said working electrode (WE1), said reference electrode (RE) and said counter electrode (CE).

Although the invention has been described with reference to a number of embodiments illustrated in the examples and figures, it should not be construed as being limited thereto. The skilled person can combine features from aspects of the invention as desired, while remaining within the scope of the invention. The full scope of the invention is as defined in the appended claims.

### EXAMPLES

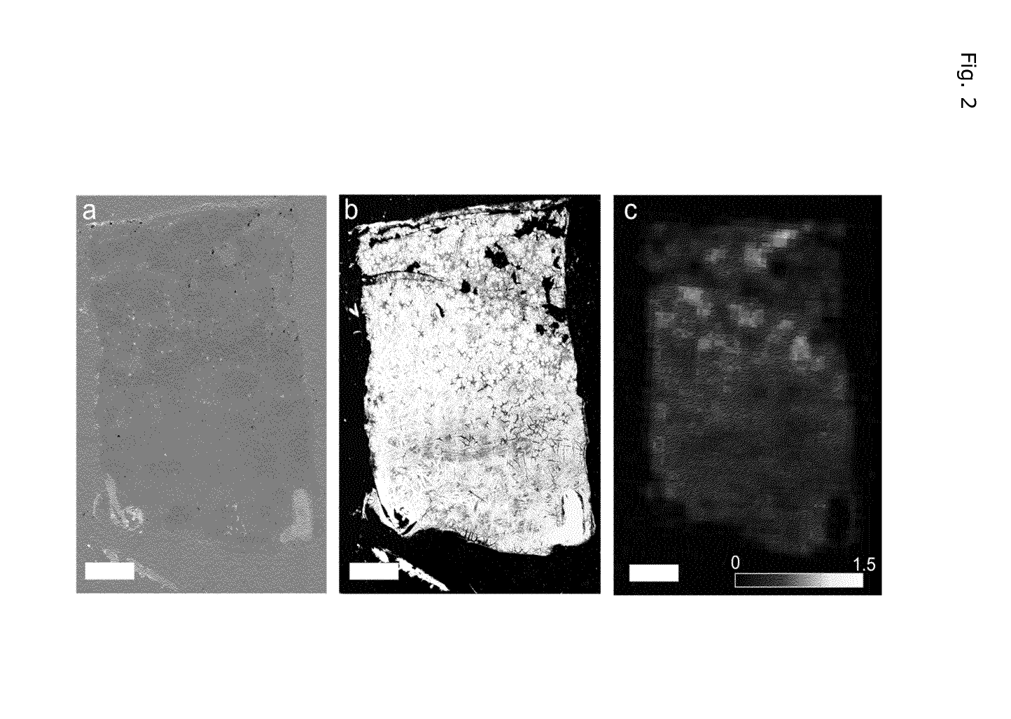

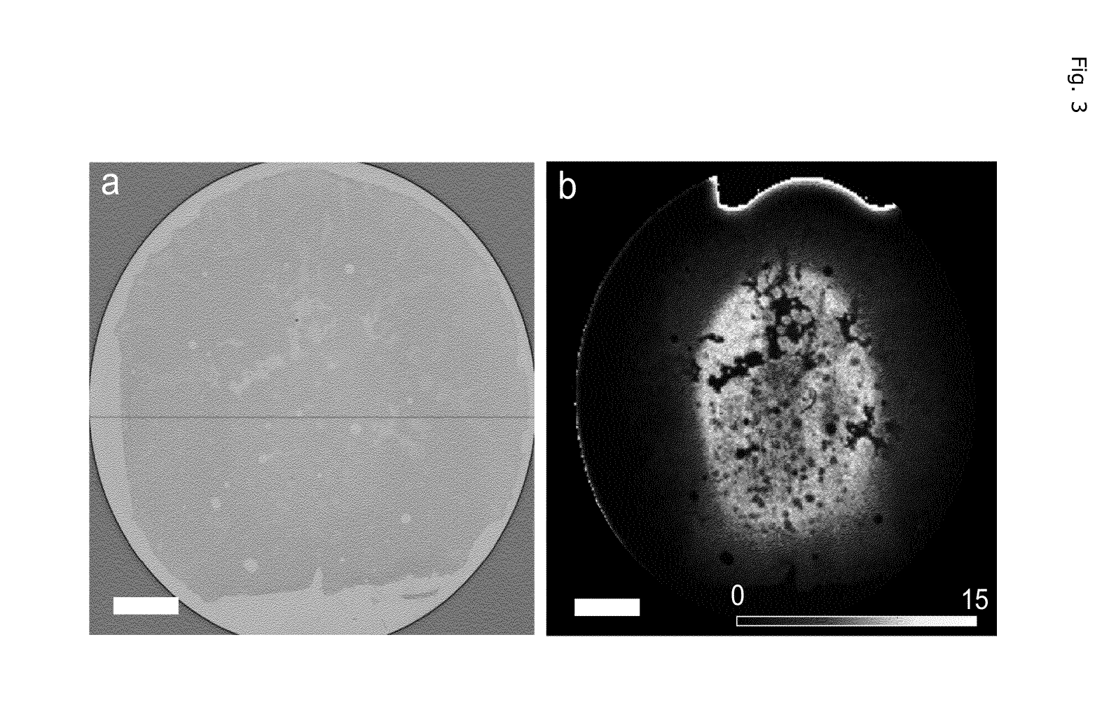

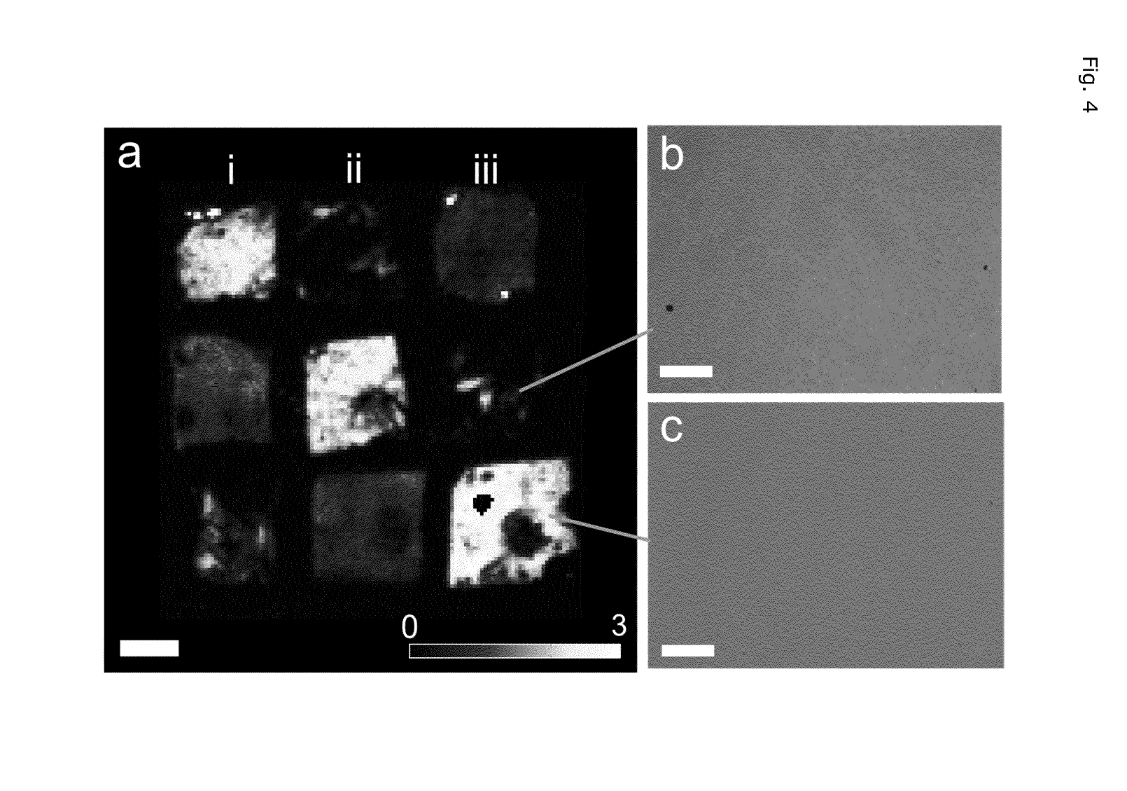

The transfer technique of the invention, called Fixed Over-potential method (FOP), is firstly compared with the most common transfer technique [FIGS. 2, 4], which involves the etching of the growth substrate [S. Bae et al. Nat. Nanotechnol. 5 (2010) 574-578]. For the comparison, a homogenous single layer of CVD graphene is grown on a copper foil. Graphene is then transferred onto a silicon oxide surface with the two different methods. Afterwards, the optical inspection of the samples shows that the coverages of the two methods are similarly above 90% (as shown for the FOP in FIG. 2b), proving the good comparability of the two techniques. Raman Spectroscopy shows that the ratios of the intensities of the D and the G peaks are for both transfers consistently below 0.2, proving a small defect density level [Andrea C. Ferrari & Denis M. Basko—Nature Nanotechnology 8, 235-246 (2013)]. Time Resolved Terahertz (THz-TDS) Spectroscopy measurements indicate that the sheet conductivity is homogenously constant all over the samples and higher for the sample transferred with the FOP method (average 2 mS) than the etched samples (average 1 mS) (FIG. 4). Transmission Electron Microscopy (TEM) images show that the density of metal particles, mainly copper residues from the growth substrates, on the transferred graphene is negligible for the FOP method of the invention, while being substantial for the etching method. The FOP method is then used to transfer graphene grown on sputtered Cu film on Si/SiO₂ 4″ wafers onto oxide substrates for the first time without delamination or compromising the copper film (FIG. 3).

### Methods

CVD Growth of Graphene

Graphene is grown on two different substrates, namely Cu foils (25 μm, Alfa Aesar, double side polished, 99.99999% purity) and sputtered Cu films (1.5 μm films grown on 4″ SiO₂ (1 μm)/Si wafers). Growth is performed in an Aixtron Black Magic vertical cold wall CVD system. Before insertion in the system, the foils are cleaned in acetone, DI water, isopropanol and then blow dried under a nitrogen flow. In the CVD system, they are first annealed at 1050° C. in H₂ (1000 s.c.c.m.)/Ar (300 s.c.c.m.) for 3 hours at 2.5 mbar. Graphene is then grown with the introduction of methane precursor (1 s.c.c.m.) for 10 min. The wafers are placed in the CVD system right after the copper layer deposition. The annealing phase lasts 10 min at 1030° C. and then graphene is grown following the recipe in ref. [Tao, L. et al—Journal of Physical Chemistry C. (2012), 116, 24068-24074].

Details of Transfer

5 μm Cellulose Acetate Butyrate (CAB, 30 k, 0.3 g/L in Ethyl Acetate) or 2 μm thick PMMA layer (996 k, 20% in Anisole) are spun (1500 rpm, 60 s) on the substrates after graphene growth and then cured at 80° C. for 10 min and 130° C. for other 10 min. Any graphene present on the uncovered (reverse) side of the foils is removed by oxygen plasma treatment (50 W, 2 min).

The etching transfer is based on two consecutive baths of ammonium persulphate (0.1 M). Firstly, the samples are left floating in the solution, with the polymer-free side facing the solution, at 85° C. for 2 hours. The samples are then moved to a fresh etching solution and left overnight (12 hours approx.) at room temperature. The FOP transfer is performed in a 1 M KCl solution. The potential is fixed at −0.4 V between the working electrode (copper/graphene/polymer) and the reference electrode (FIG. 1). The comparison with the bubbling transfer, i.e. in presence of the formation of hydrogen bubbles, is done by setting the same potential at 1.2 V. The time necessary for the polymer to detach completely from the substrate during the FOP transfer is generally several hours, depending on the surface of the substrate, and up to 24 hours for the full wafer. In the hydrogen formation regime the transfer lasts instead few minutes, as reported previously [L. Gao et al.—Nature Communications 3, Article number: 699].The graphene/polymer is then transferred into two DI water baths, 1 hour each, both sides of the samples in contact with water, and then left floating in a third water bath overnight. Afterwards, the samples are aligned on the destination substrate, in general a 300 nm silicon oxide layer, and left to dry at 80° C. for 1 hour. The temperature is then increased in small steps to 135° C. The CAB samples are left on the hot plate at 135° C. for 2 hours, while the samples with PMMA are treated similarly overnight. The CAB is the removed in ethyl acetate, while the PMMA in is removed in acetone.

Characterization

Raman The Raman spectra of graphene are taken in ambient conditions with a Thermo Fisher Raman Microscope, using a 445 nm (graphene on copper) and a 535 nm (graphene on oxide) laser source. The nominal spot size (FWHM) depends on the choice of the used lens and it is 2 μm for a 10× optical lens, 700 nm for 50× and 500 nm for 100×.

Thz Terahertz (THz=10¹² Hz) sheet conductance maps were produced from transmission THz time-domain spectroscopy (THz-TDS) data recorded using a Picometrix T-ray 4000 fiber-coupled spectrometer as described elsewhere [J. D. Buron et al.—Nano Lett., 2012, 12 (10), pp 5074-5081]. The sample was raster scanned in the x-y direction of the focal plane between the fiber coupled emitter and detector units to form spatial conductance maps with resolution down to 300 μm. By analysing the transmitted electric field time-domain waveforms on basis of Fresnel coefficients for the sample geometry (air-graphene-silicon-air), the technique allows for non-contacted measurement of the complex, frequency-dependent graphene conductance in a frequency range of 0.1-2.5 THz (0.1-1.5 for short focal length lenses).

TEM Graphene has been transferred onto Ni grids with holey carbon film for TEM inspection. The samples have been investigated using a FEI Tecnal TEM at 100 kV in bright field mode.

1. A method for separating a graphene-support layer laminate from a conducting substrate-graphene-support layer laminate, said method comprising the steps of:
a. providing a N-electrode electrochemical system, where N is 3 or more, said N-electrode electrochemical system comprising:
at least one working electrode (WE), at least one of which being said conducting substrate-graphene-support layer laminate (WE1), wherein said substrate-graphene-support layer laminate is manufactured by:
i. providing a conducting substrate upon which graphene has been deposited;
ii. coating said graphene with a layer of support layer precursor;
at least one reference electrode (RE),
at least one counter electrode (CE), and
at least one electrolyte (E) connecting said at least one working electrode (WE, WE1), said at least one reference electrode (RE) and said at least one counter electrode (CE), wherein said working electrode being said conducting substrate-graphene-support layer laminate (WE1) is in contact with a liquid electrolyte (E1) having a neutral or basic pH; and
b. applying a voltage at least between the working electrode (WE) which is said conducting substrate-graphene-support layer laminate (WE1) and at least one of said at least one counter electrodes (CE), and measuring the voltage between the working electrode (WE) which is said conducting substrate-graphene-support layer laminate (WE1) and at least one of said at least one reference electrodes (RE), such that the graphene-support layer laminate separates from said conducting substrate.

2. The method according to claim 1, further comprising treating said support layer precursor so as to provide a substrate-graphene-support layer laminate.

3. The method according to claim 1, wherein the support layer is a polymer layer, suitably selected from PMMA, CAB, PS, PVC, PVA, or co-polymers or mixtures thereof.

4. The method according to claim 1, wherein said liquid electrolyte (E1) is an aqueous liquid.

5. The method according to claim 1, wherein said N-electrode electrochemical system comprises one electrolyte (E), being said liquid electrolyte (E1) which connects all N electrodes.

6. The method according to claim 1, wherein the liquid electrolyte (E1) has a pH of 7 or more.

7. The method according to claim 1, wherein the conducting substrate is a metal, comprising Cu, Ni, Ir, Pt, Ru, Rh, Fe, W, Au, Ag, or alloys thereof.

8. The method according to claim 1, wherein the conducting substrate is a metal foil, a single crystal or a sputtered metal thin film on a carrier substrate.

9. The method according to claim 1, wherein the conducting substrate is partially etched by the electrolyte.

10. The method according to claim 1, wherein the voltage applied between the WE and the CE is less than 3 V and greater than 0 V.

11. The method according to claim 10, wherein production of hydrogen bubbles at WE1 is avoided.

12. The method according to claim 1, further comprising the steps of: applying the substrate-graphene-support layer laminate to a second substrate such that the graphene layer contacts the second substrate and removing the support layer, thus leaving the graphene on the second substrate.

13. The method according to claim 1, where N=3 and which consists of:
a working electrode (WE), being said substrate-graphene-support layer laminate (WE1),
a reference electrode (RE),
one counter electrode (CE), and
liquid electrolyte (E1) connecting said working electrode (WE1), said reference electrode (RE) and said counter electrode (CE).

14. An N-electrode electrochemical system for separating a graphene-support layer laminate from a substrate-graphene-support layer laminate, where N is 3 or more, said electrochemical system comprising:
at least one working electrode (WE), at least one of which being said substrate-graphene-support layer laminate (WE1),
at least one reference electrode (RE),
at least one counter electrode (CE), and
at least one electrolyte (E) connecting said at least one working electrode being said substrate-graphene-support layer laminate (WE1), said at least one reference electrode (RE) and said at least one counter electrode (CD), wherein said working electrode being said conducting substrate-graphene-support layer laminate (WE1) is in contact with a liquid electrolyte (E1) having a neutral or basic pH.

15. The N-electrode electrochemical system according to claim 14, in which N=3 and which consists of:
a working electrode (WE), being said substrate-graphene-support layer laminate (WE1),
a reference electrode (RE),
a counter electrode (CE), and
liquid electrolyte (E1) connecting said working electrode (WE1), said reference electrode (RE) and said counter electrode (CE).

16. The method according to claim 10, wherein the voltage applied between the WE and the CE is less than 2 V and greater than 0 V.

17. The method according to claim 10, wherein the voltage applied between the WE and the CE is less than 0.9 V and greater than 0 V.
